(19) United States
(12) Patent Application Publication
(10) Pub. No.: US 2025/0246099 A1
(43) Pub. Date: Jul. 31, 2025

(54) WIRELESS TAMPER-EVIDENT LABEL FOR A TUBE OR CONTAINER

(71) Applicant: 16095020 CANADA INC., Laval (CA)

(72) Inventors: Gourgen AMBARTSOUMIAN, Laval (CA); Luciana FRAGA DA COSTA DIESEL, Laval (CA); John WAGNER, Laval (CA); Jonathan BOU-FARAH, Laval (CA); Alexandre BEAUDOIN-GAGNE, Laval (CA)

(21) Appl. No.: 19/040,264

(22) Filed: Jan. 29, 2025

Related U.S. Application Data
(60) Provisional application No. 63/626,179, filed on Jan. 29, 2024.

(30) Foreign Application Priority Data
Dec. 4, 2024 (CA) 3258404

(51) Int. Cl. G09F 3/03; B65C 3/20; B65D 55/06; G09F 3/00; G09F 3/02; G09F 3/10

(52) U.S. Cl. CPC G09F 3/0376; B65C 3/20; B65D 55/06; G09F 3/0297; G09F 3/10; G09F 2003/0225; G09F 2003/0266; G09F 2003/0273

(57) ABSTRACT

A label for matrix tube may have a facestock optionally configured to have data on a first surface thereof. An adhesive layer may be on a second surface of the facestock. The facestock may define an end label portion, an end label portion and a neck portion between the end label portion and the end label portion, the neck portion being narrower than the end label portion and the end label portion. A method for applying a label onto a matrix tube may also be provided.

### CROSS-REFERENCE TO RELATED APPLICATIONS

The present application claims the priorities of U.S. Patent Application No. 63/626,179, filed on Jan. 29, 2024, and of Canadian Patent Application No. 3,258,404, filed on Dec. 4, 2024, the contents of both of which are incorporated herein by reference.

### TECHNICAL FIELD

The present application relates to labels for use with vials, such as bottles, tubes, vials, sample tubes, sample vials.

### BACKGROUND

Sample bottles, tubes, vials and the like are commonly used to manipulate multiple samples, for instance manually or robotically in laboratories. As the content of such bottles, tubes, vials must remain intact and unaltered, it may be desired to provide labelling that has tamper-proofing, for any tampering or attempts at tampering to leave a trace.

### SUMMARY

It is an aim of the present disclosure to provide a novel label for bottles, tubes and vials.

Therefore, in accordance with an embodiment of the present disclosure, there is provided a label for vial with cap comprising: a facestock optionally configured to have data on a first surface thereof, the facestock defines a tamper-evident label portion, an end label portion and a neck portion between the tamper-evident label portion and the end label portion, the neck portion being narrower than the tamper-evident label portion and the end label portion, an adhesive layer on at least a second surface of the facestock, and a wireless communication inlay connected to the facestock; wherein the label is sized such that when the end label portion is against an end surface of the vial or an end surface of the cap, the tamper-evident label portion is over a joint line between the vial and the cap and is adhered to a side surface of the vial and of the cap.

In accordance with another aspect of the present disclosure, there is provided a method for applying a label onto a vial, comprising pressing an end label portion against an end face of the vial or an end face of a cap on the vial; deforming the label at a neck portion to move a tamper-evident label portion toward a side surface of the vial; and pressing the tamper-evident label portion of the label into adherence against the side surface of the vial and of the cap, such that the tamper-evident label portion overlaps at least a portion of a joint line between the vial and the cap; wherein the label includes wireless communication inlay such that the method includes securing the wireless communication inlay to the vial or cap.

### BRIEF DESCRIPTION OF THE FIGURES

FIG. 1 is a perspective view of a wireless tamper-evident label as secured to a bottle/vial, in accordance with an embodiment of the present disclosure;

FIG. 2 is a perspective view of a wireless tamper-evident label as secured to a bottle/vial, in accordance with another embodiment of the present disclosure;

FIG. 3A is a face view of the wireless tamper-evident label of FIG. 1 in accordance with a variant of the present disclosure;

FIG. 3B is a rear view of the wireless tamper-evident label of FIG. 3A;

FIG. 4A is a face view of the wireless tamper-evident label of FIG. 3A, with a variant of facestock tear features;

FIG. 4B is a face view of the wireless tamper-evident label of FIG. 3A, with another variant of facestock tear features;

FIG. 4C is a face view of the wireless tamper-evident label of FIG. 3A, with yet another variant of facestock tear features;

FIG. 4D is a face view of the wireless tamper-evident label of FIG. 3A, with yet another variant of facestock tear features;

FIG. 4E is a face view of the wireless tamper-evident label of FIG. 3A, with yet another variant of facestock tear features;

FIG. 5 is a face view of a wireless tamper-evident label in accordance with another variant of the present disclosure;

FIG. 6 is a face view of a wireless tamper-evident label in accordance with yet another variant of the present disclosure;

FIG. 7 is a schematic sectional view of an exemplary construction of the wireless tamper-evident label of the present disclosure;

FIG. 8 is a face view of a labelling kit including the wireless tamper-evident label of FIG. 3A, in accordance with another embodiment of the present disclosure; and

FIG. 9 is a flow chart of a method for for applying a label onto a vial in accordance with another variant of the present disclosure.

### BRIEF DESCRIPTION OF THE EMBODIMENTS

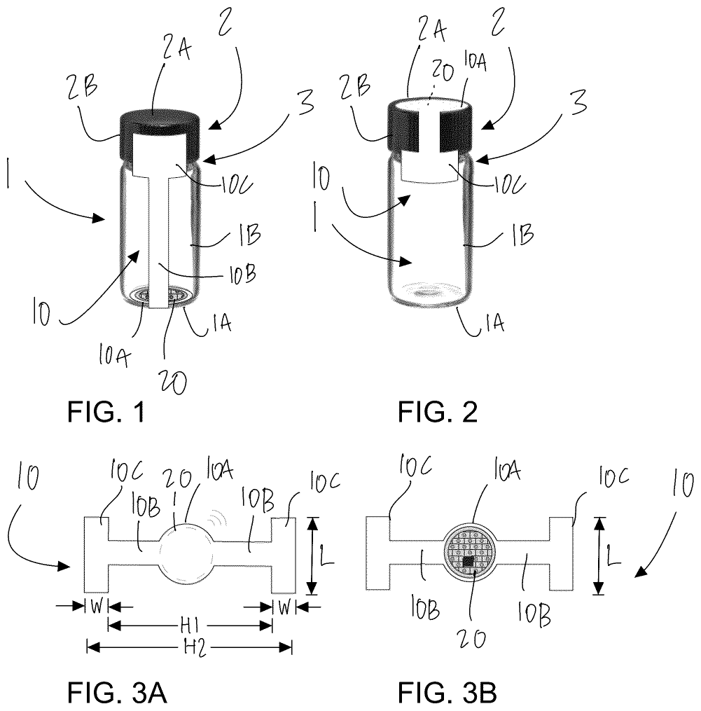

Referring to the drawings and more particularly to FIGS. 1 and 2, a bottle/vial is generally shown at 1 with cap 2 for use with a wireless tamper-evident label 10 in accordance with the present disclosure. The vial 1 may also be known as sample tube, sample vial, sample bottle. For simplicity, reference is made herein to vial 1, although the vial 1 may be known as other names. The vial 1 may come in different sizes between 0.3 ml (milliliters) and 10 L (liters). The vial 1 has a cylindrical shape (as a possibility among others), and is open ended so as to receive a sample(s) in its inner cavity. Some examples of other shapes of vials may include square, rectangle, oval, elliptical, conical, tapered, spherical, hexagonal, octagonal, polygonal, asymmetrical, custom shapes, branded shapes, flask-shaped, amphora-shaped, jar-shaped, etc. The vial 1 has a bottom face 1A (a.k.a., bottom surface 1A) and a cylindrical side surface 1B, or like side surface if not cylindrical. In the illustrated embodiment, the bottom face 1A is round (as a possible shape among others), and has a diameter between 0.4 cm and 50 cm. A height of the bottle/vial 1 may depend on the volume of the bottle/vial 1, and is usually between 2.0 cm and 75.0 cm without cap, though other heights outside this range are contemplated. In an embodiment, a central axis of the vial 1 is coincident with a center of the cylindrical side surface 1B. In a variant, the vial 1 may be used upside down. Accordingly, the bottom face 1A may also be referred to as an end face 1A. The end face 1A or bottom face 1A (also referred to as surface) may be said to be at the end of the side surface 1B, and defines the closed end of the vial 1, at the opposite end of the open end of the vial 1.

The cap 2 may be sealingly received in the top open end of the vial 1. In an embodiment, it can be said that the cap 2 is an integral part of the vial 1 (i.e., when referring to “vial 1”, this may include the cap 2, though one could refer to the assembly of vial and cap as a vial assembly for example), but the cap 2 may not be part of the vial 1. The cap 2 may have an end face 2A and a side surface 2B. In the illustrated embodiment, the side surface 2B is cylindrical in shape, as an example, but other shapes are possible, including frusto-conical (i.e., a truncated cone). The cap 2 is typically made of an elastomer by which the cap 2 is sealingly received and held captive while capping off the vial 1, for the sample in the vial 1 to be isolated from ambient by the cap 2. In the embodiments of FIGS. 1 and 2, the cap 2 may be said to be a push-in cap 2, in that it is pushed into engagement with the vial 1, the assembly relying on elastic deformation for the cap 2 to be captive to the vial 1. The cap 2 may also be a screw cap, for threaded engagement with the vial 1, with appropriate threading being present in the vial 1 and on the cap 2. The cap can be a screwcap, external thread, or internal thread, or a push-in, friction closure cap, snap-cap. The assembly of vial and cap can instead be a set-up box, a cryogenic box, a freezer box, a goblet. Other cap materials may be used, the elastomer being an example among others. The caps might have some other parts associated with it such as a swab or brush linked to the internal portion of the cap for the purpose of swabbing a sample from a patient. In an embodiment, the bottle/vial/jar may be packaged inside a sealed packaging. In an embodiment, the bottle/vial/jar is sterile. In an embodiment, the bottle/vial/jar is DNase free. In an embodiment, the bottle/vial/jar is DNA free. In an embodiment, the bottle/vial/jar is RNase free. In an embodiment, the bottle/vial/jar is RNA free. In an embodiment, the bottle/vial/jar is fingerprint-free. In an embodiment, the bottle/vial/jar is sterilized by gamma radiation. In an embodiment, the body of bottle/vial/jar is fully transparent. In an embodiment, the body of bottle/vial/jar is transparent at certain location. In an embodiment, the body of bottle/vial/jar is closed with the cap inserted or screwed.

As observed from FIGS. 1 and 2, the vial 1 and the cap 2 may have the same or similar cross-sectional shapes and dimensions, e.g., the same diameter. When the cap 2 is on the vial 1 as in FIGS. 1 and 2, there is a joint line 3 between them. The joint line 3 may be referred to as a junction, intersection, seam, etc, and may be geometrically defined as being an annular gap or channel, a clearance. In some embodiments, the sizing, the shapes and the complementary engagement features between vial 1 and cap 2 may be such that the joint line 3 may be relatively seamless, e.g., the assembly of the vial 1 and cap 2 may appear to be a continuous cylinder of constant diameter, in spite of the presence of the annular joint line 3. Also, it is possible for the cap 2 and the vial 1 to have differing cross-sectional dimensions and/or shape, yet with the wireless tamper-evident label 10 usable and functional in spite of this. In a variant, both the vial 1 and the cap 2 have a diameter D. Therefore, the length L of the joint line 3 may be said to be equal to a circumference of the πD. If the cross-sectional dimensions of the vial 1 are smaller than that of the cap 2, it can be said that the joint line 3 has a length equal to a periphery of a larger of the vial 1 and cap 2.

Referring concurrently to FIGS. 1 and 2, the wireless tamper-evident label 10 for vial 1 is shown as applied to the vial 1, in a tamper-evident connection. The expression “tamper-evident” is used herein to indicate that any attempt to remove the cap 2 from a remainder of the vial 1 will be visible, through an alteration in the wireless tamper-evident label 10. The label 10 may crumble or be destroyed when tampered with. As an alternative to the expression “tamper-evident”, the label 10 may be said to be tamper-proof. Moreover, the wireless tamper-evident label 10 is said to be wireless, as it has an electronic chip thereon enabling wireless identification thereof.

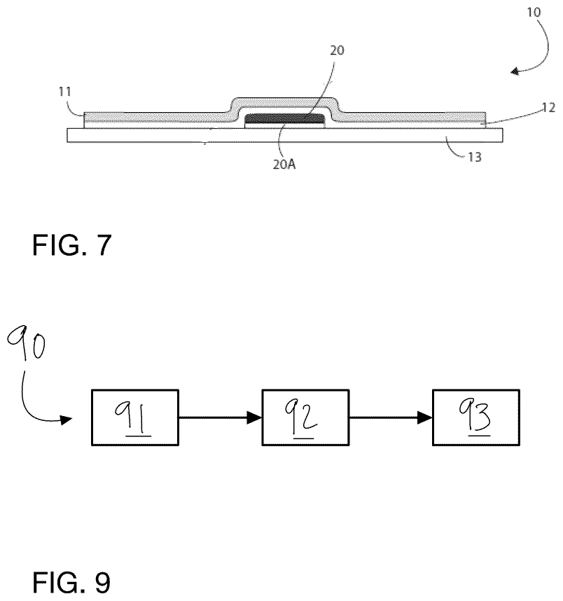

Referring concurrently to FIGS. 1, 2, 3A and 3B, the wireless tamper-evident label 10 may have a monolithic or monoblock construction (though with an electronic component added to the monoblock), but may have different parts, such an end label portion 10A, one or more necks 10B, and one or more tamper-evident label portion(s) 10C. An exemplary construction of the wireless tamper-evident label 10 will be described below with reference to FIG. 7.

The end label portion 10A acts as a support for an electronic chip, as described below. The end label portion 10A configured to be adhered to the bottom face 1A of the vial 1 as in FIG. 1, or to the end face 2A of the cap 2 as in FIG. 2 (or base 2 if the combination of FIGS. 1 and 2 is flipped over), though it may also be connected elsewhere, such as the side surfaces of the vial 1 or cap 2. In an embodiment, the end label portion 10A emulates the shape of the bottom face 1A or end face 2A, and may be said to be circular, though it may be more appropriate to qualify the end label portion 10A as being quasi-circular as it is tied to the neck 10B and therefore does not define a full 360-degree circle. The end label portion 10A may have other shapes, including square, squircle, polygon, a combination of shapes, etc. In an embodiment, the end label portion 10A has a diameter ranging from 0.2 cm to 5.0 cm, this range applying to the largest cross-sectional dimension (e.g., not a diameter, such as an octagon or like polygonal shape) if the end label portion 10A is not circular or quasi-circular. The size of the end label portion 10A may be determined by the size of a RF or NFC antenna or inlay 20 it will support, through the RF inlay may be elsewhere on the label 10. The diameter of the end label portion 10A may be smaller, equal or larger than that of the bottom face 1A. In an embodiment, any type of data may optionally be provided on the end label portion 10A, such as symbols, letters and/or numbers. The data may be pre-printed, or may be printed in situ. The printing of the label 10 may be done after the vial 1 has been labelled, by using for example a tube printing or label printing device. For example, the data may be in the form of a 1D, barcode, 2D barcode, 3D barcode, or QR code. The data on the end label portion 10A may differ from data on other parts of the label, such as on the tamper-evident label portion 10C, notably because of size restrictions. For example, the data on the end label portion 10A may be a QR code, 2D barcode, 3D barcode while the data on the tamper-evident label portion 10C, if any, may be a barcode. Other data pairings are possible, including on the neck portion 10B. Furthermore, any portion of the label 10 may have printing such as a logo, trade name, or any image or graphic alone or together with data or information or any indicia, including holographic images, sequential numbering, microtext. In an embodiment, the data on any portion of the label is directly read from the NFC or RFID tag and printed within the same pass through the RFID or NFC printer. In other words there is no manipulation of data and the printing device has a capability to read and print it within a single operation.

The neck(s) 10B joins the end label portion 10A to the tamper-evident label portion(s) 10C. In an embodiment, the neck 10B is straight from the end label portion 10A to the tamper-evident label portion 10C, though other shapes are possible, such as a straight flare, an arcuate flare. At the junction with the end label portion 10A, the neck 10B has a width smaller than the diameter of the end label portion 10A (or maximum cross-sectional dimension). This width at the junction may be the smallest width of the neck 10B if it is not straight, and of the label 10 altogether. Stated differently, the edges of the neck 10B may be straight, from the end label portion 10A to the tamper-evident label portion 10C. Other shapes are considered, such as arcuate, with a non-linear increasing slope from the end label portion 10A to the tamper-evident label portion 10C. Some additional examples of neck portion may include wavy lines, zig-zag, pattern, asymmetric, intermitting lines with shapes, combination of lines, combination of shapes, combination of lines and shapes. Although the rectangle portion 10C is shown having 90° angles one or more corners of 10C may have corner angles from 1° to 179°. Tamper-evident label portion of 10C may have any shape or line pattern. Additional features of the tamper-evident label portion 10C may include corner cut-outs of any shape or angle. Any the aforementioned features can be used singularly or in-combination with and all and every portion of the label 10.

Referring to FIGS. 1, 2, and 3A-3B, the tamper-evident label portion 10C may be generally rectangular or square, or have such an elongated shape (e.g., oval). The tamper-evident label portion 10C may have square corners as shown, but the corners may be rounded, etc. The tamper-evident label portion 10C is configured to adhere to the side surface 1B of the vial 1, and to the side surface 2B of the cap 2, so as to overlap the joint line 3. The elongated shape of the tamper-evident label portion 10C is well suited to be adhered to the side surfaces 1B and 2B, with the elongated dimension extending along the joint line 3. This may increase the retention force of the label 10 into the vial 1 and cap 2, when the tamper-evident label portion 10C is applied to the side surface 1B and 2B. In an embodiment, the tamper-evident label portion(s) 10C cover(s) at least 50% of the joint line 3. Hence, it may be said that the tamper-evident label portions 10C have a combined length L of 0.70 πD. Each tamper-evident label portion 10C may be said to have a length of at least 0.35 πD in the embodiments featuring two of the tamper-evident label portions 10C. In a variant, the combined length of the tamper-evident label portions 10C are enough to cover all of the joint line 3, such that the tamper-evident label portions 10C overlap one another, though this is optional. The combined length of the tamper-evident label portions 10C would be of at least πD.

In the embodiments of FIGS. 1, 2, 3A, 3B and 4A-4E, the wireless tamper-evident label 10 has two neck portions 10B and two tamper-evident label portions 10C. The neck portions 10B are advantageously narrower than the tamper-evident label portions 10C, so as not to obstruct the see-through view capability of the assembly of vial 1 (including cap 2) and label 10 when assembled in the tamper-evident configuration as in FIG. 1. Indeed, in spite of the presence of the neck portions 10B adhered to the side surface 1B, the narrowness of the neck portions 10B are such that a portion of the side surface 1B remains exposed, for one to see through it. While the embodiments show that an axis of symmetry may be present for the outer shape of the various embodiments of the wireless tamper-evident label 10, there may be no such symmetry. In an embodiment, any type of data may be provided on the tamper-evident label portion 10C, such as barcode(s), symbols, letters and/or numbers, or any combination thereof. In an embodiment, the unique identifier of the NFC tag or RFID tag is printed on the label 10.

In embodiments described herein, the size of the neck portion(s) 10B must be selected as a function of the dimensions of the vial 1. Different label sizes may be provided as a function of the vial size, to ensure that the tamper-evident label portion(s) 10C overlap the joint line 3 while the end label portion 10A is against the end face 2B of the lid 2 or the bottom face 1B of the vial 1. For example, with reference to FIG. 3A, the label 10 is shown with value W for the tamper-evident label portions 10C. This represents the width or height of the tamper-evident label portion(s) 10C, with this dimension W being on the joint line 3 during use, such as with the dimension W being generally centered on the joint line 3. To achieve this, the label 10 may be said to be label-specific, in that the label 10 is configured specifically for a given type of vial 1. Dimensions H1 and H2 are therefore selected to ensure that the dimension W overlaps suitably the joint line 3. In a variant, the end label portion 10A is centered relative to H1 and H2, for the end label portion 10A to be on the top of the cap 2 or bottom of the container 1, depending on the contemplated usage.

The label 10 may be opaque, transparent, translucent, hazy or have any degree of opacity, transparency, translucency or haziness or any combination thereof. The label may have a background color, a thermochromic ink, any coating, varnish or lamination.

By having a portion narrower than the end label portion 10A and than the tamper-evident label portion 10C, the neck 10B may exhibit a greater flexibility than the end label portion 10A and tamper-evident label portion 10C. Stated differently, the neck 10B may offer a lesser resistance to deformation, and/or may produce less biasing force when deformed in the manner shown in FIG. 1 and in FIG. 2. The neck 10B in use is indeed curved or folded.

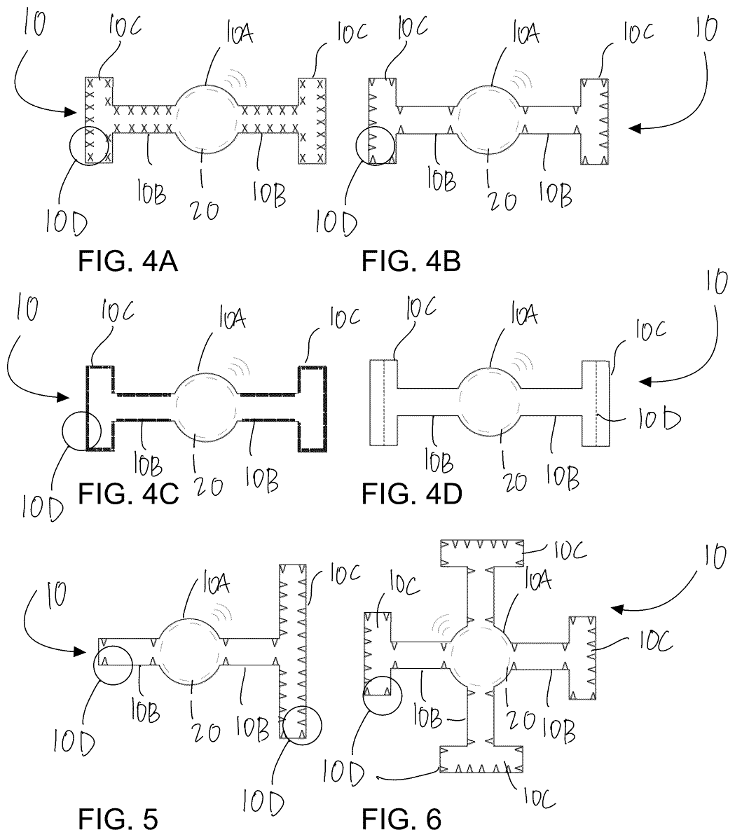

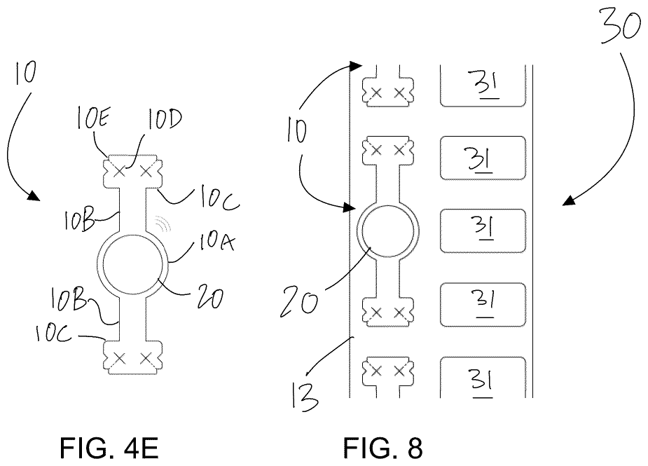

Referring to FIGS. 4A to 4E, the wireless tamper-evident label 10 is shown having tear features 10D of various configurations. The tear features 10D may be a series of perforations in the tamper-evident label portion 10C and/or in the neck portion 10B, or like weakening of the facestock, to enable the manual tearing of the tamper-evident label portion 10C and/or of the neck 10B from the moment a relative displacement is imparted between the vial 1 and the cap 2. In FIG. 4A, the tear features 10D are X-shaped slits or weakenings in the facestock, with the tear features 10D being at or near the edges of wireless tamper-evident label 10. In FIG. 4B, the tear features 10D are chevron-shaped slits or weakenings in the facestock, with the tear features 10D being at or near the edges of wireless tamper-evident label 10. These are only two examples of potential shapes. In FIG. 4C, the tear features 10D are micro-tear cuts in the facestock, with the micro-tear cuts being from the edges of wireless tamper-evident label 10. The micro-tear cuts may be as described in U.S. Pat. No. 11,319,464, incorporated herein by reference. In FIG. 4D, the tear features 10D are defined as being a tear line. In a variant featuring the tear line 10D, the wireless tamper-evident label 10 is sized for the tear line to be over the joint line 3 between the vial 1 and the cap 2. In FIG. 4E, some cutouts are present in the tamper-evident label portions 10C, with the cutouts leading to tear features 10D. The cutouts may further induce tearing of the tear features 10D, by directing shear forces to the tear factures 10D. FIGS. 4A to 4E are only some of the examples of possible tear features 10D. Any combination of the tear features 10D is possible. The tear features 10D could be arranged to leave facestock in the form of VOID upon removal. In FIG. 4E, it can be observed that the tear features 10D include a concave outline in a perimeter of the tamper-evident label portions 10C, shown for example, as a concavity 10E. The concavity 10E is aligned with a slit or like weakening in the facestock of the tamper-evident label portions 10C.

Referring to FIG. 5, another embodiment of the wireless tamper-evident label 10 is shown. In the embodiment of FIG. 5, the wireless tamper-evident label 10 has a single tamper-evident label portion 10C. The wireless tamper-evident label 10 has two neck portions 10B, for example to ensure that the wireless tamper-evident 10 is suitably connected to the vial 1 or cap 2, i.e., to avoid a detachment of the end label portion 10A. In such a variant, the tamper-evident label portion 10C may be at least 30% longer than the tamper-evident label portion 10C of a wireless tamper-evident label 10 having two such tamper-evident label portions 10C (e.g., embodiments of FIGS. 3A-3B and 4A-4E), to ensure suitable retention force between tamper-evident label portion 10C and side surfaces 1B and 2B. In a variant, the tamper-evident label portion 10C is long enough to cover all of the joint line 3, such that the tamper-evident label portion 10C overlaps itself, though this is optional. In the embodiment of FIG. 5, the tamper-evident label portion 10C has a length L of at least 0.50 πD. The neck portion 10B and the tamper-evident label portion 10C are arranged in a T-shape, but other shapes are possible, including a L-shape.

Referring to FIG. 6, another embodiment of the wireless tamper-evident label 10 is shown. In the embodiment of FIG. 6, the wireless tamper-evident label 10 has a four neck portions 10B and four tamper-evident label portion 10C. The neck portion 10B and the tamper-evident label portion 10C are arranged in a T-shape, but other shapes are possible, including a L-shape. In a variant, the combined length of the tamper-evident label portion 10C are enough to cover all of the joint line 3, such that the tamper-evident label portions 10C overlap one another, though this is optional. In an embodiment, the wireless tamper-evident label 10 may have three neck portions 10B and the three tamper evident label portions 10C, arranged radially in a symmetrical or non-symmetrical fashion (not shown).

In the embodiments of FIGS. 5 and 6, some tear features 10D are present. They are optional. They are shown as being chevron-shaped slits or weakenings, but could be any other type of tear feature 10D.

Referring to FIG. 7, the wireless tamper-evident label 10 may have various layers, all of which may extend from end to end of the label 10. Facestock 11 is the exposed surface, that may optionally accept ink or printing, although the capability of accepting ink is not a requirement. This may include printing using a thermal printer, a thermal-transfer printer, a direct-thermal printer, a laser printer, an inkjet printer, LED printer, UV printer, impact printer, dot-matrix printer, laser-etching printer, flexographic printer, offset printer or a printing press or any other type of printer or device capable of delivering ink on any of the surfaces of the label. Accordingly, the facestock 11 may incorporate a thermochromic ink system (such as leuco dye), for example in a layer of coating that is part of the facestock or incorporated in the material of the facestock, for the color to be revealed upon heating. The facestock 11 itself may include one or more layers, including transparent and opaque layers, shielding layer(s), top coatings, inks, varnishes, laminations, etc.

Referring to FIG. 8, the wireless tamper-evident labels 10 are shown as being part of a kit 30 that includes one or more wireless tamper-evident labels 10, and one or more label 31. It may be required that the user of the wireless tamper-evident labels 10 use the label 31 to note in a separate document the vial(s) 1 that has (have) been labeled. Thus, the label(s) 31 may have data that corresponds to the data on a corresponding one of the wireless tamper-evident labels 10. The kit 30 may have the labels 10 and 31 share a common release liner 13.

In a variant, the RF or NFC antenna or inlay 20 may be encoded or protected in any appropriate manner, for the information thereon to be accessible by selected user, such as by using a password or like authentication. Thus, the user having access to the data programmed into the inlay 20 may then verify it with the data printed on the label 10. It would then be possible to determine whether the container 1 has been tampered with, such as by the replacement of the label 10 with another.

The wireless tamper-evident labels 10 can be provided blank or pre-printed, and/or may be with any background color or color indicator such as thermochromic ink, and/or image, and/or information and/or barcode and/or alphanumeric markings, and/or indicia etc. The facestock materials can be made of a polymer, or of a paper such as an impregnated paper. The facestock material(s) may include but is not limited to polymer(s) such as any type of thermoplastic film, any type of polypropylene, biaxially oriented polypropylene (BOPP), polyester (PET), polystyrene, vinyl including polyvinyl chloride (PVC) and polyvinyl fluoride (PVF), acrylate, nylon, satin, polyethylene, polyimide, tyvek, composite materials, silicone, silicone rubber, rubber, synthetic rubber, latex, thermoset plastics, plastic extrusion materials, and may also include cloth tissues, woven or non-woven fabrics, foam, metallic foils such as aluminum foil, Velcro®, degradable and soluble materials such as water soluble materials including biodegradable or compostable materials. The facestock materials include paper and polymer composites or combinations, cloth and polymer composites or combinations, including layers of polymer and paper and/or cloth, such that the paper or cloth is for example laminated with plastic. Embossed, stamped foil, clear, opaque, transparent, translucent and/or reflective materials or any combination thereof may also be used for the facestock 11. The polymers may be thermoplastics or thermos-softening plastics, i.e., plastic polymers that soften or become moldable when heated to a certain threshold temperatures, to solidify upon cooling. The polymers may be thermoset plastics comprising cross-linked polymers to form an irreversible chemical bond and may become non-moldable when heated. The facestock 11 may be selected to have direct thermal printing capacity meaning that an ink system (e.g. leuco-dye) is incorporated inside the facestock 11 or in its top coating. The ink may then be released upon heating the facestock layer 11 such as by a thermal printer or a heat-emitting or heated instrument. The facestock 11 may be for example printed or coated with a non-reversible (e.g., leuco dye) or a reversible thermochromic ink sytem which may also be also incorporated inside or applied on the facestock or other constituent of the label 10 such as onto the lamination or inside the adhesive. For example, the label 10 may be a shielded direct thermal label as in U.S. Pat. No. 11,472,214, a direct thermal label as in PCT application publication No. WO2022/201133, and/or may be a direct thermal label capable of withstanding steam autoclave. The use of a combination of printing methods is contemplated. All wireless tamper-evident labels 10 of the present disclosure may or may not accept writing by a pen, pencil, marker or any other instrument for inscribing or manual writing.

In some variants, a thickness of the facestock 11 may be equal to or less than about 8.0 mil. More specifically, the label facestock 11 may have a thickness of between about 0.3 mil and 6.0 mil, and even more specifically, the facestock 11 may have a thickness of between about 0.4 mil and 4.8 mil, or of between about 0.8 mil and 3.5 mil, or still more specifically, of between about 0.9 mil and 3.2 mil. The thickness of the facestock can be within the range of 0.3 mil and 30 mil.

An adhesive layer 12 may be coated on the underside of the facestock 11. A support liner or release liner 13 may also be provided upon which the labels 10 are laid, from which the adhesive layer 12 with the facestock 11 can be released. In an embodiment, the label 10 does not include the release liner 13, though it may come on the release liner 13. In another embodiment, the label 10 may be linerless. The support liner 13 may have a surface coating (a.k.a., release coating) or any low adherence surface or feature, upon which the adhesive layer 12 is laid, to facilitate the separation of the facestock 11 and adhesive layer 12 from the support liner 13.

The adhesive in the adhesive layer 12 may be any type of adhesive including pressure-sensitive adhesives, and non-limitative examples include a water-based acrylic, an emulsion adhesive, a hot melt including a UV hot melt, a rubber-based adhesive, a latex-based adhesive, a solvent-based adhesive, a silicon-based adhesive, a UV-curable adhesive, a LED-curable adhesive including a LED-UV-curable adhesive, EB (Electron-Beam) curable adhesive, IR (Infra-Red) curable adhesive, Heat-curable adhesive, radiation curable adhesive, two-part or multi-part adhesives that consist of two or more components that are mixed together for starting the curing process, any radiation curable adhesives, a cross-linked adhesive, heat activated adhesive, adhesives for cold-stamping or hot-stamping, any combination thereof, etc. Similarly, in a variant, the adhesive can be permanent. To ensure proper adhesion, the adhesive may be said to be permanent or ultra-permanent in some embodiments. The adhesive of the adhesive layer 12 can also be a glove-friendly. It is noted that any pressure-sensitive adhesive could be used. In some implementations, the adhesive of the adhesive layer 12 can be weakened or even neutralized at one or more locations using any adhesive neutralizing agent such as a varnish, an ink or UV varnish, a UV ink or the like. For example, it is considered to have such weakened or neutralized adhesive in the neck portion(s) 10B of the wireless tamper-evident label 10. In some implementations, the adhesive 12 can be applied according to a certain pattern covering only a portion of the facestock 11 such that a remaining portion of the facestock undersurface is devoid of any adhesive. For example, the neck portion 10B could be without adhesive. These configuration of neutralized adhesive of absence of adhesive in the neck portion 10B may be used as a tamper-evident feature, as an attempt to removal the cap 2 may result in a tear of the neck portion 10B while the tamper-evident label portion 10C remains adhered to the cap 2.

The adhesive layer 12 may have a thickness equal to or less than about 15.0 mil. In an embodiment, the adhesive layer 12 could have thickness of between 0.3 mil and 4.0 mil. More specifically, the adhesive layer 12 could have a thickness of between about 0.05 mil and 2.0 mil, and even more specifically, the adhesive layer 12 could have a thickness of between about 0.4 mil and 1.5 mil, or of between about 0.6 mil and 1.2 mil, or still more specifically, of between about 0.7 mil and 1.0 mil.

The release liner 13 may be paper based, or polymer based, with contemplated polymers including a polyester (PET), polypropylene, bi-axially oriented polypropylene (BOPP) or any other type of a polymer or thermoplastic film. For example, the release liner 13 may be a silicone or fluorosilicone coated or fluoropolymer coated support on which the adhesive layer 12 is harboured or retained, though other materials can be used, including waxes or other adhesive release coatings, etc, on a substrate. For example, if the support liner 13 is paper based such as glassine or super-calendared including super-calendared kraft (SCK), Clay coated including clay-coated kraft (CCK), Polyethylene coated including polyethylene coated kraft (PEK), a low friction coating (e.g., silicone, fluorosilicone, fluoropolymer-coated, or non-silicone based release coating) may be present to facilitate the peeling off of the facestock 11 and adhesive layer 12 from the support liner 13. Accordingly, when the release liner 13 is removed, the facestock 11 may be adhered to the vial surface, by the adhesive layer 12. In another embodiment, the release liner 13 may have imaging properties meaning that the manual writing with a pen or a pencil or with any type of impact instrument or impact printer can create a copy of the image on the release liner 13. In this case, when the facestock 11 is removed from the liner 13, the copy of the printed information or the image remains on the release liner 13 similar to carbon-copying. In another embodiment, the label 10 has a paper based facestock and a paper-based release liner 13. In another embodiment, the label 10 has a paper based facestock and a polymeric release liner 13. In an embodiment, the release liner 13 is coated on both sides with a release coat to allow the release of the label 10 and on the other side to prevent sticking of the adhesive of the label from the coil beneath in case of oozing or adhesive migration. In another embodiment, the label 10 has a polymeric facestock 11 and a paper-based release liner 13. In another embodiment, the label 10 has a polymeric facestock 11 and a polymeric release liner 13. In another embodiment, the polymeric facestock 11 has an elongation value over 10% in either Machine Direction (MD) or Traverse Direction (TD) prior to breaking as measured according to ASTM D-882A (American Standard Testing Method). In another embodiment, the polymeric facestock 11 has an elongation value over 20% in either Machine Direction (MD) or Traverse Direction (TD) prior to breaking as measured according to ASTM D-882A. In another embodiment, the polymeric facestock 11 has an elongation value over 40% in either Machine Direction (MD) or Traverse Direction (TD) prior to breaking as measured according to ASTM D-882A. In another embodiment, the polymeric facestock 11 has an elongation value over 80% in either Machine Direction (MD) or Traverse Direction (TD) prior to breaking as measured according to ASTM D-882A. In another embodiment, the polymeric facestock 11 has an elongation value over 120% in either Machine Direction (MD) or Traverse Direction (TD) prior to breaking as measured according to ASTM D-882A. In another embodiment, the polymeric facestock 11 has an elongation value between 120% and 1200% in either Machine Direction (MD) or Traverse Direction (TD) prior to breaking as measured according to ASTM D-882A.

Still referring to FIG. 7, an RF (radio frequency) inlay 20 may be adhered to the adhesive layer 12, though it may be integrated in the wireless tamper-evident label 10 in other ways, such as by being embedded in the facestock 11. The RF inlay 20 is designed for wireless communications, and may have all necessary components for such purpose, including the capacity in some embodiments to be encoded. The RF inlay 20 may have memory for encoding additional information. The information programmed into the RF inlay 20 may be the same as at least part of the data that is printed on the label 10, but this is optional. In a variant, all data on the label 10 and programmed into the RF inlay 20 corresponds to the content of the vial 1, but this is optional, or additional data may be present. The RF inlay 20 may be programmed with a unique identifier for example, and this data may be printed on the label 10. The expression RF inlay and wireless communication inlay are used to indicate any wireless communication device for label, including RF tag, chip, electronic chip, RFID, RFID label, Radio Frequency identification tag, NFC tag, Near Field Communication tag, HF (high frequency radio frequency), UHF (ultra high frequency radio frequency), NFC label, transponder, wireless communication device of any appropriate frequency, to name only a few of the numerous appellations possible for the RF inlay 20. For consistency, the expression RF inlay will be used herein. The RF inlay 20 may typically include a circuit component, for example circuitry, with an antenna, inlaid in a casing. The casing may be made of any appropriate material, such as polyester, polypropylene, Biaxially Oriented Polypropylene (BOPP), polyethylene or any other polymer based material. The casing may be defined as a laminated layer(s) of film, whether transparent or not. The RF inlay 20 may include a wireless communication component or may be configured to communicate wirelessly by technologies such as RFID (Radio Frequency Identification), NFC (Near Field Communication), Bluetooth®, or other type of wireless communication tags, sensor, electronic component, etc. The RF inlay 20 can be of any shape such as a square, rectangle, circle, oval, trapezoid, triangle, polygon, as an example. Any of the shapes may have straight or rounded corners. The term RF in the present disclosure implies the use of any wireless communication device that may have an electronic component capable of receiving or transmitting any type of wireless communication of any frequency or comprising any data that can be accessed or transmitted wirelessly, whether passively or actively i.e., without or with battery respectively. The RF inlay or the tag may be capable of functioning on any surface or container. In an embodiment, the RF inlay may have a capability to function on a plastic surface. In an embodiment, the RF inlay may have a capability to function on a metal surface. In an embodiment, the RF inlay may have a capability to function on a vial, tube, or bottle containing any type of substance including but not limited to liquid, solid, powder, metal of any type or origin, granules, beads, ink, gas, paste, cream, gel, fuel, oil, chemical, biological or organic substance, cells, gunpowder of any type or origin, projectile of any origin, bullet of any type, shell of any type, mixture, matter.

The RF inlay 20 may optionally include an adhesive layer 20A, i.e., it may be a wet tag (with the adhesive layer 20A) or dry tag (without the adhesive layer 20A). FIGS. 3A and 3B are illustrative of both a wet tag and a dry tag configuration for the RF inlay 20. The adhesive in the adhesive layer 20A may be any type of adhesive including pressure-sensitive adhesives, and non-limitative examples include a water-based acrylic, an emulsion adhesive, a hot melt including a UV hot melt, a rubber-based adhesive, a latex-based adhesive, a solvent-based adhesive, a silicon-based adhesive, radiation curable adhesive, heat-curable adhesive, a UV-curable adhesive, a LED-curable adhesive including a LED-UV-curable adhesive, EB-curable adhesive, a cross-linked adhesive, heat activated adhesive, adhesives for cold-stamping or hot-stamping, any combination thereof, etc. Similarly, in a variant, the adhesive can be permanent, while in another scenario, the adhesive can be removable and/or repositionable, allowing repositioning of the RF inlay 20 on a surface. The adhesive of the adhesive layer 20A can also be a glove-friendly removable adhesive, for example. It is noted that any pressure-sensitive adhesive could be used. If present, the adhesive layer 20A may have a thickness equal to or less than about 10.0 mil. More specifically, the adhesive layer 20A could have a thickness of between about 0.05 mil and 3.0 mil, and even more specifically, the adhesive layer 20A could have a thickness of between about 0.4 mil and 2.0 mil, or of between about 0.6 mil and 1.5 mil, or still more specifically, of between about 0.7 mil and 1.0 mil, or still more specifically, of between about 0.5 mil and 1.2 mil. The facestock 11 may be coated with a different adhesive than the RF inlay adhesive 20A or both adhesives may be the same. Moreover, although not shown, the RF inlay 20 may come on a release liner at some point before being adhered onto the adhesive layer 12 as in FIG. 7.

The RFID or NFC inlay 20 can be of any shape circle, rectangle, triangle, square, polygon, oval, parabolic, non-geometrical or any geometrical shape, symmetric or asymmetric shape.

A plurality of the wireless tamper-evident labels 10 may share a common release liner 13, the release liner 13 being in the form of a roll. In an embodiment, the facestock 11 covers all of the release liner 13 in the roll 20, with the wireless tamper-evident labels 10 being die-cut so as to be removable from the release liner 13. In such a case, a waste portion of facestock 11, defining contours of the labels 10, would be present. As other embodiments, the release liner 13 may be in the form of a sheet (such as a letter size 8.5″×11″, 8.5″×14″ or A4, or other sheet format) with rows and columns of the any of the wireless tamper-evident labels 10, or in the form of flat strips with rows of the labels 10, booklet, fanfold, etc. In an embodiment, when the labels 10 are intended for printing in a laser printer, a LED printer or any other type of printer in a sheet format, the release liner 13 may be resistant to heat without curling when it is passed through such a printer. Such release liners are also known as “layflat” liners. In some cases the layflat liners are thicker than regular release liners, and may be for example up to 7.0 mil in thickness or more. In the embodiments described herein, the label 10 can be positioned in any orientation on a roll or sheet, such as landscape, portrait, vertical, with any appropriate angle. An orientation can be provided to facilitate automatic peeling from a peeling device or from a robotic device. In an embodiment, the label 10 comes in a kit. The kit may include one or more of the labels 10, such as labels 10 on the release liner 13, and one or more vials 1, including or not the cap 2. The kit may include the presence of a cap(s) 2, already on the tube(s) 1, or not. The kit may also include the presence of a liquid or other substance in the vial 1. Some or all of the components of the kit may be sterile (i.e., sterilized), nucleic acid free (e.g. DNA, RNA, etc.), or enzyme-free (such as DNase or RNase) as an option.

In a variant, the label 10 described herein may be applied onto a vial by: pressing an end label portion of a bottom face of the vial or an end face of a cap on the vial; deforming the label at a neck portion to move a tamper-evident label portion toward a side surface of the vial; and pressing the tamper-evident label portion of the label into adherence against the side surface of the vial and of the cap, such that the tamper-evident label portion overlaps at least a portion of a joint line between the vial and the cap. The tamper-evident label portion may be adhered first, or after the end label portion has been adhered. The label may include a wireless communication inlay such that the method includes securing the wireless communication inlay to the vial or cap. In an embodiment, the data and/or barcode is printed on the label 10 with one operation of reading the RFID or NFC chip 20, and printing the data from the RFID or NFC chip on the facestock 11 of the label 10 using a RFID or NFC printer is performed without additional pass through a printer. Optionally, a database is used for printing data on the facestock 11 and programming the RFID or NFC chip 20 simultaneously using a RFID or NFC printer wherein the printed information may or may not be identical to the information encoded on the chip 20 during the printing process. A system may be used to simultaneously verify the information printed on the label 10 and information encoded on the RFID or NFC chip 20, such as a system described in U.S. patent application Ser. No. 17/826,888, incorporated herein in its entirety by reference.

The label configurations and methods described hereinafter may be used in any industry where labels are used. Some implementations of the label configurations and methods may further be particularly well suited for use in certain industries. In particular, the labels used in some industries-such as in biotechnology, biomedicine, cell banking, tissue banking, forensic, jewelry, electronic and other fields involving cryogenic bio-preservation or freezing of biological specimen—are typically required to be thinner and more flexible than in other fields and are therefore substantially more difficult to peel using prior art methods. For example, it has been shown that cryogenic label materials that are intended for use at −80 C and below such as inside mechanical freezers and liquid nitrogen tanks at −196 C or below or that are exposed to liquid helium at −269 C may have facestock elongation values between 10% and 500% or even more. It will however be understood that the label configurations and methods described hereinafter are not limited to use in these fields, and may be used instead in other fields such as packaging, automotive, electrical, electronics, avionics, aerospace, food, chemical, agricultural, fashion, gas and oil, plumbing, heavy industrial, light industrial, construction, or any other suitable filed or industry. The label 10 may be applied to a container such as a vial, a bottle partially going over the portion of the main body of the container and over the cap that can open to input, manipulate, store, exit or transport any type of a sample.

The label 10 may be sterile using any method of sterilization including but not limited to steam autoclave, ethylene oxide, gamma radiation, Ultraviolet radiation, dry heat sterilization, chemical sterilization, electron beam sterilization, plasma gas sterilization. The containers 1 may be sterile, depyrogenated, RNase free, DNase free, DNA-free, RNA-free, nucleic acid free, biological matter free, pyrogen free, dust free. In an embodiment, the label 10 may be capable to already frozen vials such as surface temperature being between −40° C. and −196° C.

The bottle or vial 1 may contain any substance including but not limited to liquid, amorphous, solid, crystalline, gel, paste, powder, mixtures (homogeneous or heterogeneous), gaseous substance, biological material, any type of metal, metallic substance, metallic object, wood, cellulose based material, wooden object, any object, paint, ink, coating, solvent, polymer, chemical substance, compound, plasma, animal, condensate, ionic substances, stone, precious stone, precious metal, radioactive material, hazardous materials, biohazardous materials, elements, compounds, nucleic acids including DNA, RNA, and their derivatives, variants and synthetic versions, amino acids, proteins, prion, cells, virus, bacteria, fungi, medication, vaccine, serum, antibody, specimen, biological specimen, body fluid, anatomical part, insect, organism, animal, protozoa, environmental samples, plant, plant parts, enzyme, hormones, metabolites, vitamins, lipids, carbohydrates, space matter such as meteor sample, space dust, or any matter originated from outer space. In a variant, the bottle, vial or jar may contain a toxin of any origin. In a variant, the bottle, vial or jar may contain a fuel, an accelerant, an explosive, etc. In a variant, the bottle, vial or jar may contain an electronic device, electronic component, information storage. In a variant, the bottle, vial or jar may contain a firearm or any component of it, ammunition or any component of it, metal of any type or origin, gunpowder of any type or origin, projectile of any origin, bullet of any type, and/or shell of any type. In a variant, the bottle, vial or jar may contain a product for human or animal consumption.

Referring to FIG. 9, a method in accordance with a variant of the present disclosure is generally shown at 90, and may for example be performed with various embodiments of the wireless tamper-evident label 10. The method may be a method for applying a label onto a vial. The method 90 may include various steps, including step 91 of pressing an end label portion against an end face of the vial or an end face of a cap on the vial; step 92 of deforming the label at a neck portion to move a tamper-evident label portion toward a side surface of the vial (deforming meaning for example curving the neck portion from a generally flat configuration); step 93 of pressing the tamper-evident label portion of the label into adherence against the side surface of the vial and of the cap, such that the tamper-evident label portion overlaps at least a portion of a joint line between the vial and the cap. Steps 91, 92, 93 may be performed in different orders. Steps 92 and 93 may be repeated such as if the label has more than one neck portion and a tamper-evident label portion. The label includes wireless communication inlay such that the method includes securing the wireless communication inlay to the vial or cap. In a variant, the wireless communication inlay is in the end label portion, whereby the step 91 of pressing the end label portion against the end face of the vial or the end face of the cap on the vial includes positioning the wireless communication inlay on the end face of the vial or the end face of the cap. The method may further include inserting a sample in the vial and putting the cap on the vial. The method may further include tearing at least one of the tamper-evident label portion when moving the cap relative to the vial.

1. A label for vial with cap comprising:
a facestock defining a tamper-evident label portion, an end label portion and a neck portion between the tamper-evident label portion and the end label portion, the neck portion being narrower than the tamper-evident label portion and the end label portion,
an adhesive layer on a surface of the facestock, and a wireless
communication inlay connected to the facestock;
wherein the label is sized such that when the end label portion is against an end surface of the vial or an end surface of the cap, the tamper-evident label portion is over a joint line between the vial and the cap and is adhered to a side surface of the vial and of the cap.

2. The label according to claim 1, wherein the wireless communication inlay is adhered to the adhesive layer.

3. The label according to claim 1, wherein the neck portion and the tamper-evident label portion at an end thereof form a T-shape portion of the label.

4. The label according to claim 1, including at least two of the neck portion and at least two of the tamper-evident label portion for a single one of the end label portion.

5. The label according to claim 1, wherein tear features are defined in the neck portion and/or in the tamper-evident label portion.

6. The label according to claim 5, wherein the tear features are slits and/or weakenings in the facestock.

7. The label according to claim 1, wherein the end label portion has a generally circular shape.

8. The label according to claim 7, wherein the wireless communication inlay is connected to the end label portion.

9. The label according to claim 1, wherein the neck portion has a constant width from the tamper-evident label portion to the end label portion.

10. The label according to claim 1, wherein the tamper-evident label portion has a generally rectangular or square shape.

11. The label according to claim 1, wherein the tamper-evident label portion has a barcode, data and/or ink thereon.

12. The label according to claim 11, further including data on the end label portion, wherein the data on the end label portion differs from data on the tamper-evident label portion.

13. The label according to claim 1, wherein the data on the end label portion is a QR code or 2D barcode.

14. The label according to claim 1, further including a support liner, the adhesive layer being between the facestock and the support liner, for releasable connection of the facestock to the support liner.

15. The label according to claim 1, wherein the label is configured to be attached to a frozen container.

16. The label according to claim 1, wherein the wireless communication inlay is NFC, UHF or HF.

17. The label according to claim 1, wherein the facestock is configured to have data on another surface thereof.

18. A kit comprising:
at least one of the labels according to claim 1, and a vial including a cap.

19. A method for applying a label onto a vial, comprising:
pressing an end label portion against an end face of the vial or an end face of a cap on the vial;
deforming the label at a neck portion to move a tamper-evident label portion toward a side surface of the vial; and
pressing the tamper-evident label portion of the label into adherence against the side surface of the vial and of the cap, such that the tamper-evident label portion overlaps at least a portion of a joint line between the vial and the cap;
wherein the label includes wireless communication inlay such that the method includes securing the wireless communication inlay to the vial or cap.

20. The method of claim 19, wherein the wireless communication inlay is in the end label portion, whereby pressing the end label portion against the end face of the vial or the end face of the cap on the vial includes positioning the wireless communication inlay on the end face of the vial or the end face of the cap.
